(19) United States
(12) Patent Application Publication
(10) Pub. No.: US 2026/0326348 A1
(43) Pub. Date: Oct. 22, 2026

(54) BASE MATERIAL FOR SILK FIBROIN MOLDED BODY AND THE MANUFACTURING METHOD

(71) Applicant: CANON VIRGINIA, INC., Newport News, VA (US)

(72) Inventors: Akira YANE, Shinagawa-ku (JP); Yu KAMENO, Yokohama (JP); Koki KODAIRA, Ohta-ku (JP); Toshiyuki TOMITA, Yokohama (JP); Kota YAGI, Ohta-ku (JP)

(21) Appl. No.: 19/105,670

(22) PCT Filed: Aug. 22, 2022
(86) PCT No.: PCT/US2022/075293

§ 371 Date: Feb. 21, 2025

(51) Int. Cl. B29C 43/00; B29C 43/04; B29C 43/52; B29C 43/58; B29C 71/02

(52) U.S. Cl. CPC B29C 43/003; B29C 43/04; B29C 43/52; B29C 43/58; B29C 71/02; B29C 2043/5808; B29C 2043/5816; B29K 2089/00; B29K 2995/0063

(57) ABSTRACT

The present disclosure provides a fibroin molding method and a molded body that enable easy release from a mold even in the case of a complicated mold shape, wherein the fibroin is heated and pressurized inside a mold and then heat-treated outside the mold.

### FIELD OF THE DISCLOSURE

The present disclosure relates to a base material for silk fibroin molding and to its manufacturing method.

### BACKGROUND

International Patent Application Publication No. 2017/047503 provides a molded article obtained by filling a mold with a powder of a protein containing a natural spider silk protein which is silk fibroin or a polypeptide derived from a natural spider silk protein, and heating and pressurizing it.

### SUMMARY OF THE DISCLOSURE

In the conventional method, when a mold shape became complicated, there were cases where the strength of the fibroin was so strong, it did not come off from the mold, or the molded body was damaged when it was removed from the mold.

The present disclosure provides a fibroin molding method and a molding body that enable easy release from a mold, even in case of a complicated mold shape.

Specifically, the present disclosure proposes a method for producing a fibroin molded body, the method comprising a process of loading the fibroin into a mold, a process of heating and pressurizing the fibroin, a process of taking out the pressurized fibroin, and a process of heat-treating the taken out fibroin molded body.

It is therefore possible to easily release a fibroin molded body from a mold, even in case of a complicated mold shape.

These and other embodiments, objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

The accompanying drawings, which are incorporated herein and form part of the specification, illustrate various embodiments, objects, features, and advantages of the present disclosure.

FIG. 1 is a schematic diagram of a mold for silk fibroin molding.

FIG. 2 is a schematic diagram of a mold for silk fibroin molding used in at least one embodiment.

FIG. 3 is a schematic diagram of a top piston for silk fibroin molding used in at least one embodiment.

FIG. 4 is a schematic diagram of a mold for silk fibroin molding used in at least one embodiment.

FIG. 5 is a schematic diagram of a block for lyophilization used in at least one embodiment.

FIG. 6 is a schematic diagram of a block for lyophilization used in at least one embodiment.

FIG. 7 is a schematic diagram of a block for lyophilization used in at least one embodiment.

FIG. 8 is a schematic diagram of a block for lyophilization used in at least one embodiment.

FIG. 9 is a schematic diagram of a block for lyophilization used in at least one embodiment.

FIG. 10 is a schematic diagram of a mold for silk fibroin molding used in at least one embodiment.

FIG. 11 is a schematic diagram of a mold for silk fibroin molding used in at least one embodiment.

FIG. 12 is a schematic diagram of a mold for silk fibroin molding used in at least one embodiment.

FIG. 13 is a schematic diagram of a mold for silk fibroin molding used in at least one embodiment.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims. Furthermore, each embodiment described can be made or used in combination with any other described embodiment.

### DETAILED DESCRIPTION

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

The method for producing a fibroin molded body in the present disclosure comprises a process of loading the fibroin into a mold, a process of heating and pressurizing the fibroin, a process of taking out the pressurized fibroin, and a process of heat-treating the taken-out fibroin molded body.

By applying a pressure at a temperature higher than the glass transition temperature to the fibrous silk fibroin, as it conforms to the shape of the mold and changes form, the air between the silk fibroin is expelled, it is integrated, and a transparent molded body is molded. At this stage the silk fibroin is integrated, but has a low flexural modulus. On the other hand, its elongation at yield point is high, it can be greatly plastically deformed and easily removed from a complicated mold. By placing the silk fibroin molded body that was taken out from the mold in an environment having the glass transition temperature or higher, β-sheets are formed between the silk fibroins, and, in addition, by collecting the β-sheets to form crystals, it becomes a molded body with a high flexural modulus.

Below, silk fibroin, mold molding, heat treatment, and measuring method will be described separately.

### Silk Fibroin

Silk fibroin is a fibrous protein that can be extracted from cocoons and/or nests.

The extraction of silk fibroin can be carried out, for example, by the method described in WO 2006/101223.

Silk fibroin is generally characterized by high ratios of glycine, alanine, serine, and tyrosine. Silk fibroin can exemplify a silk fibroin derived from an organism classified into the orders of Lepidoptera, Hymenoptera, or Araneae. In addition, it may also be silk fibroin obtained via gene recombination technology.

Furthermore, additives may be added to silk fibroin to the extent that it does not impair its properties.

And, there are no particular restrictions on the form of silk fibroin that is loaded into a mold. Examples can include a silk fibroin aqueous solution obtained by dialysis after dissolving degummed silk fibroin in a LiBr aqueous solution that has been lyophilized or crushed silk fibroin that has been lyophilized, and, those compressed into cylindrical, polygonal, spherical or hemispherical shapes. The bulk density of these silk fibroins can be about 0.50 g/cm³ or more and less than about 1.20 g/cm³. If the bulk density is low, the tableting strength is low, and the tablet breaks up when loading it into a mold and easily scatters around, so the bulk density can be about 0.70 g/cm³ or more, about 0.90 g/cm³ or more, or about 1.00 g/cm³ or more. However, as an upper limit, the bulk density can be less than 1.20 g/cm³ or less than 1.10 g/cm³ because surface transferability deteriorates during molding.

In addition, since it is possible to adjust the bulk density of silk fibroin, which scatters easily due to a condition of low bulk density when handling it in the air, it can be beneficial to instead weigh an aqueous solution of silk fibroin in an amount containing 1/n (n is an integer) of the amount of silk required for the fibroin molding, put the weighed aqueous solution into a block for lyophilization having an empty through hole, conduct lyophilization in the weighed state, compress the silk fibroin in the block for lyophilization, and adjust the bulk density. The block for lyophilization may be a mold for molding. And, the number of through holes prepared in the block for lyophilization may be one or more.

### Exemplary Configurations for Molding

As described herein, various configurations for molding can be used. In certain embodiments, aqueous fibroin solution is first converted into a base material for molding via heat and pressure or lyophilization. The base material for molding can then be compressed into a final molded body using a mold. Certain exemplary configurations for such molding processes will be described by means of the accompanying figures. It is noted that descriptions of one configuration are equally applicable to other configurations having the same functionality and use. For instance, if a part is described as being capable of having its temperature adjusted in one configuration, the same would also be possible for other configurations utilizing that same part.

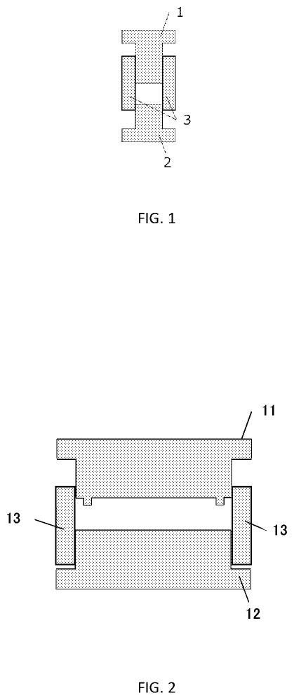

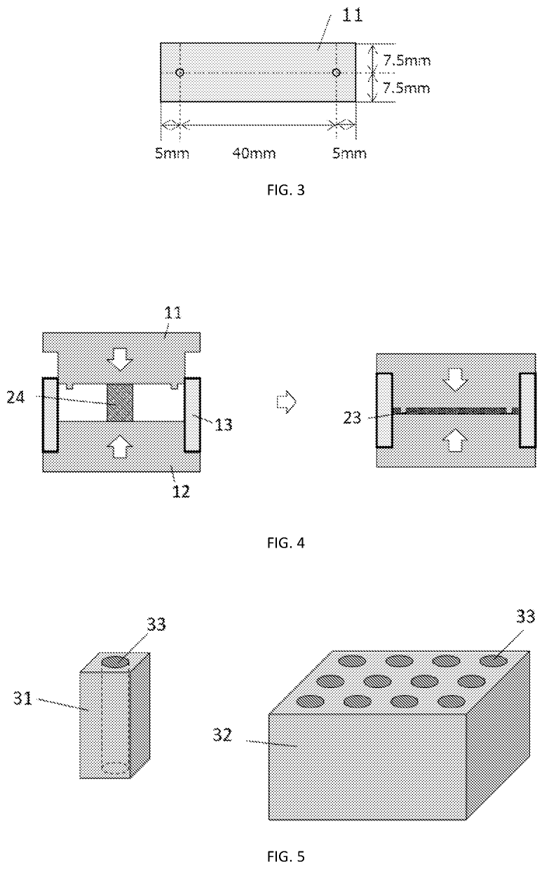

FIG. 1 is a schematic diagram of an example of a mold that can be used for molding silk fibroin. The mold is comprised of a part (mold) 3, of which the temperature can be adjusted, having a through-hole and an upper piston 1 and a lower piston 2, and a silk fibroin molded body can be obtained by loading silk fibroin into part 3 and compressing it by moving pistons 1 and 2 up and down. Alternate configurations of molds having this or similar activation methods can be used, for example, as found in FIG. 2. FIG. 2 provides a part 13 having a through hole, along with upper piston 11 and lower piston 12. As can be seen, upper piston 11 comprises certain protrusions along the lower edge which will contact the silk fibroin, thereby altering the form into which the silk fibroin molded body will be compressed. FIG. 3 provides a bottom view of the upper piston 11, which further depicts the protrusions as cylindrical protrusions. As shown in FIG. 3, for the upper piston 11, a piston having a cylindrical protrusion of 2 mm in diameter and 1 mm in height at a position of 5 mm from the end of a piston having a length of 50 mm was used. For the lower piston 12, a piston without a protrusion was used. Based on the molded body desired, any shape or form of protrusions can be utilized from either or both of the upper and lower pistons.

In one embodiment, a base material 24 for molding is placed into part 13 having upper piston 11 and lower piston 12 as shown in FIG. 4. The base material 24 is then pressurized and heated to form the molded body. As shown in FIG. 3, the upper piston 11 of FIG. 4 comprises cylindrical protrusions. A mold (part) 13, having a square columnar through-hole with a length of 50 mm and a width of 15 mm was used.

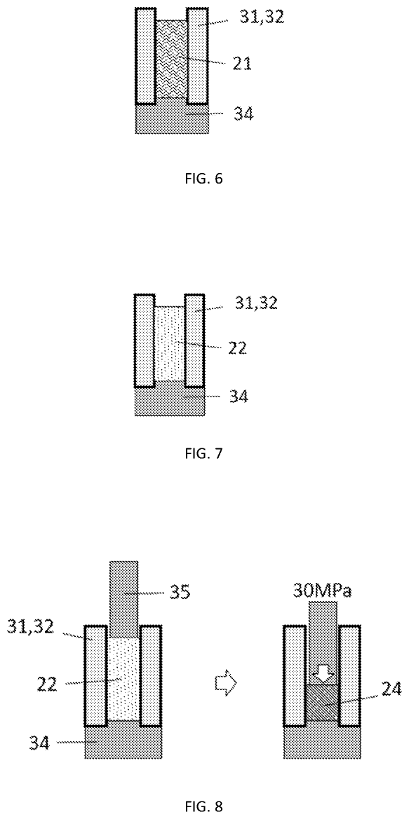

FIG. 5 depicts blocks for lyophilization 31, 32 which can be used to lyophilize one portion or multiple portions of an aqueous silk fibroin solution. The aqueous solution portions are loaded in through-holes 33. As depicted in FIG. 6, blocks 31, 32 for lyophilization have fibroin solution holder 34 located at the distal end of the through hole 33, which retains the aqueous fibroin solution 21 within through hole 33. As shown in FIG. 7, the entire block 31, 32 can be lyophilized, resulting in lyophilized silk fibroin 22 located in through hole 33, which is retained in through hole 33 of block 31, 32, by fibroin solution holder 34. The lyophilized silk fibroin 22 can then be subjected to compression via piston 35 to obtain base material for molding 24, as depicted in FIG. 8. The piston 35 can be applied through the upper opening of through hole 33 in block 31, 32, which then compacts the lyophilized silk fibroin 22 between piston 35 and fibroin solution holder 34, resulting in base material for molding 24.

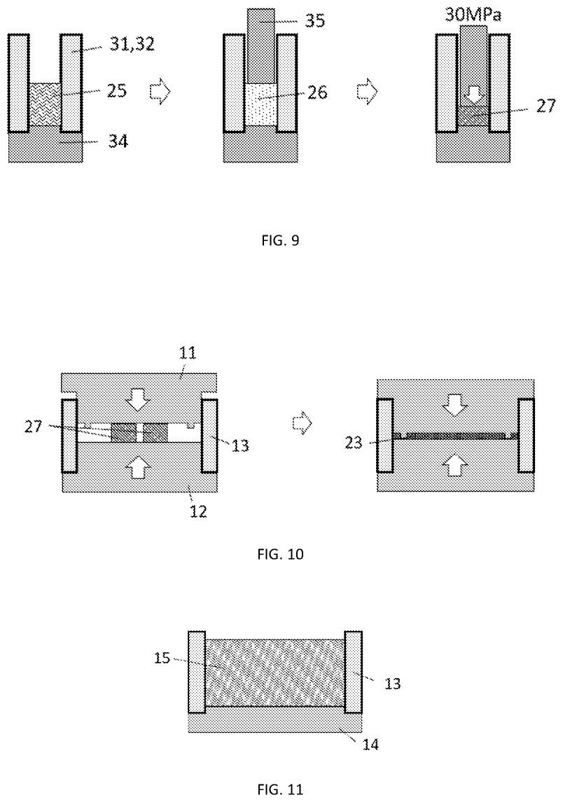

A further embodiment is depicted in FIG. 9, wherein block 31, 32 for lyophilization contains a fibroin solution in which 1/n portion of the molded part is weighed 25, which is contained within through hole 33 and retained within through hole 33 by fibroin solution holder 34. The block 31, 32 is then lyophilized, and lyophilized fibroin solution in which 1/n portion of the mold part is weighed 26 is compressed within through hole 33 by piston 35, resulting in base material for molding of 1/n portion of the molded part 27.

As depicted in FIG. 10, n portions (depicted in FIG. 10 as 2 portions) of base material for molding 1/n portion of the molded part 27 are placed in mold (part) 13, which are then compressed by upper piston 11 and lower piston 12 to form molded body 23.

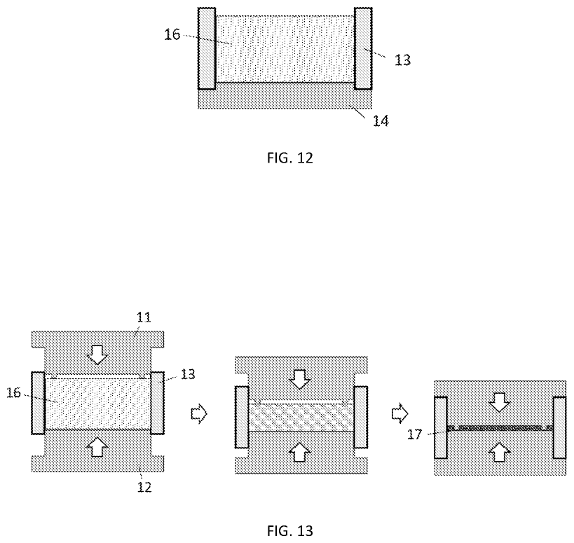

In a further embodiment, as shown in FIG. 11, an aqueous fibroin solution 15 can be loaded into a mold 13 and held in place by fibroin solution holder 14, wherein the entire mold can then be lyophilized. As shown in FIG. 12, this results in the aqueous fibroin solution 15 being of a changed state to lyophilized silk fibroin 16, wherein the lyophilized silk fibroin 16 is already present within mold 13 for a final molded body. Such lyophilized silk fibroin 16 is retained within mold 13 by fibroin solution holder 14, which can then be removed as shown in FIG. 13, with the fibroin solution holder 14 replaced by lower piston 12. Upper piston 11 can be positioned at the upper opening of through hole 33, such that lyophilized silk fibroin is then bracketed on either end of the through hole 33 by upper piston 11 and lower piston 12. Upper piston 11 and lower piston 12 can apply pressure to lyophilized silk fibroin 16, resulting in molded body 17.

### Mold Molding

A silk fibroin molded body can be obtained by loading silk fibroin of which the bulk density has been adjusted into a mold and heating and pressurizing it. As described above, FIG. 1 is a schematic diagram of an example of a mold that can be used for molding silk fibroin. The mold is comprised of a part 3, of which the temperature can be adjusted, having a through-hole and an upper piston 1 and a lower piston 2, and a silk fibroin molded body can be obtained by loading silk fibroin into part 3 and compressing it by moving pistons 1 and 2 up and down.

The temperature of the mold in the heating and pressurizing process can be from 70° C. to 200° C., or from 100° C. to 150° C. Below 70° C., the protein does not fully integrate. On the other hand, at temperatures of 200° C. and above, there is a concern that the protein may begin to decompose and the strength may decrease. Pressurization can be performed at 10 MPa or higher. At 10 MPa or lower, the protein does not sufficiently integrate, so there will not be sufficient strength for a molded body. Optionally, pressurization can be conducted at 50 MPa or higher. In addition, the applied pressure can be at about 1000 MPa or lower. The time for maintaining the pressure after the predetermined pressure is reached can be from 1 to 300 seconds, or from 10 to 30 seconds. Furthermore, the time from loading the silk fibroin into the heated mold to pressurizing and taking it out of the mold can be less than 500 seconds, or less than 300 seconds. If the time is long, crystallization progresses, and the flexural modulus (bending modulus) of the molded body increases, so that a large force may be required to release it from the mold, or damage may occur.

Furthermore, since the process of adjusting the bulk density is not required and movement of the base material for the molded body is not required, the molding processes can be reduced and the weight of the molded body portion can be configured with high accuracy. Therefore, it is also possible to obtain the molded body by weighing the silk fibroin aqueous solution, loading the aqueous solution obtained by weighing the amount of silk required for the fibroin molded body into a mold, lyophilizing it in the weighed condition, and heat and compress the silk fibroin in the mold in which the lyophilization was conducted.

### Heat Treatment

The heat treatment methods are not particularly restricted. There are methods such as heating with heated air in a thermostatic furnace, heating with heat transfer from a top plate on a hot plate, and infrared heating with an infrared heater that can all be used. The heat treatment temperature can be from 70° C. to 200° C., or from 100° C. to 150° C. Below 70° C., the molded body does not become sufficiently strong, because the silk fibroin does not integrate sufficiently. On the other hand, at 200° C. or higher, there is a concern that the decomposition of the silk fibroin may start and the strength may decrease. The heat treatment time can be 600 seconds or more. If it is less than 600 seconds, the molded body will not become sufficiently strong because crystallization does not proceed sufficiently. Furthermore, the heat treatment time should be sufficiently long, for example, longer than the heating and pressurizing time in the mold. Thus, the heating and pressurizing time in the mold can be shortened.

### Measuring Method

Hereinafter, a measurement method necessary for the present disclosure will be described.

Measurement of the bulk density was determined by the beads substitution method. Specifically, quartz sand (0.3~0.5 mm) of which the weight was measured in advance was put into a volume surveying instrument, and then silk fibroin was loaded into the surveying instrument, and the bulk density was estimated from the increase in the weight and volume of the surveying instrument.

The flexural modulus was measured using an Instron universal testing machine (Model 5582, Instron). The distance between the fulcrums of three-point bending was fixed at 27 mm, and the measurement speed was set at 1 mm/min. The flexural modulus was determined from the displacement (strain) of 0.05 up to 0.25%.

The mold release force was measured using an Instron universal testing machine (Model 5582, Instron). A mold was installed in the equipment, and the upper and lower pistons were separated and released at a speed of 10 mm/sec. The maximum stress at this time was defined as the mold release force.

### EXAMPLES

### Example 1

Silkworm cocoons were washed with water and then boiled in a 0.02 mol/L sodium carbonate aqueous solution for 30 minutes to conduct degumming. The refined silk fibroin was put into a 9.3 mol/L LiBr aqueous solution and dissolved by agitating it at 60° C. for 4 hours. Cellulose tubes 30/32 (molecular weight cut off of 12000~14000) manufactured by Sekisui Chemical Co., Ltd. were used for desalination. The concentration of the fibroin aqueous solution after desalination was diluted with pure water so it became 5%.

The obtained 5% fibroin aqueous solution was divided into portions of 39.0 ml each into containers. The divided fibroin solution was lyophilized using the freeze dryer (FD-550P) manufactured by Tokyo Rikakikai Co., Ltd. For the conditions of lyophilization, after freezing the solution at −30° C., the atmosphere was depressurized, and then the temperature was raised to −6° C., and lyophilization was conducted for 100 hours. Next, 1 piece of silk fibroin, which was divided into small portions and lyophilized, was loaded into a mold having 5 mm diameter cylindrical through-holes, pressurized at 25° C. and 30 MPa, and then taken out to obtain base material for molding.

The bulk density of the obtained base material for molding was measured to be 1.02 g/cm³.

Subsequently, as shown in FIG. 4, the base material for molding was heated and pressurized. For the mold, a mold having a square columnar through-hole with a length of 50 mm and a width of 15 mm was used. As shown in FIG. 3, for the upper piston, a piston having a cylindrical protrusion of 2 mm in diameter and 1 mm in height at a position of 5 mm from the end of a piston having a length of 50 mm was used. For the lower piston, a piston without a protrusion was used.

1 piece of base material for molding was loaded into a mold whose temperature was previously adjusted to 120° C., and after pressurizing it at a pressure of 500 MPa for 10 seconds, it was set in a mold release force measuring instrument, and it was released from the mold so the time from the start of heating came to 30 seconds. The mold release force was 0.76 kN, and the mold release was easily accomplished. In the present embodiment, the mold was pressurized in a preheated state, but preheating is not necessarily required. However, by preheating the mold in advance, the merit of shortening the molding time can be obtained.

The obtained molded body was heat-treated in a 120° C. temperature lowering furnace for 600 seconds. When the flexural modulus after heat treatment was measured, sufficient strength was obtained at 6.2 GPa.

### Comparative Example A

When the flexural modulus was measured without conducting heat treatment after the molded body was obtained by the same operation as in Example 1, a sufficient strength of 1.8 GPa was not obtained.

### Example 2

A molded body was prepared and heat-treated with the same operation as in Example 1, except that the pressure during molding was set to 20 MPa. For the mold release force, mold release was easily accomplished at 0.56 kN. The flexural modulus was 4.2 MPa, and sufficient strength was obtained.

### Example 3

A molded body was prepared and heat-treated with the same operation as in Example 1, except that the pressure during molding was set to 10 MPa. For the mold release force, mold release was easily accomplished at 0.41 kN. The flexural modulus was 2.8 MPa, and sufficient strength was obtained.

### Example 4

A molded body was prepared and heat-treated with the same operation as in Example 1, except that the temperature during molding was set to 70° C. For the mold release force, mold release was easily accomplished at 0.54 kN. The flexural modulus was 4.5 MPa, and sufficient strength was obtained.

### Example 5

A molded body was prepared and heat-treated with the same operation as in Example 1, except that the temperature during molding was set to 50° C. For the mold release force, mold release was easily accomplished at 0.45 kN. The flexural modulus was 2.3 MPa, and sufficient strength was obtained.

### Example 6

A molded body was prepared and heat-treated with the same operation as in Example 1, except that the temperature during molding was set to 150° C. For the mold release force, mold release was easily accomplished at 0.71 kN. The flexural modulus was 5.9 MPa, and sufficient strength was obtained.

### Example 7

A molded body was prepared and heat-treated with the same operation as in Example 1, except that the temperature during molding was set to 180° C. For the mold release force, mold release was easily accomplished at 0.32 kN. The flexural modulus was 3.5 MPa, and sufficient strength was obtained.

### Example 8

A molded body was prepared and heat-treated with the same operation as in Example 1, except that the pressurization time during molding was set to 1 second. For the mold release force, mold release was easily accomplished at 0.74 kN. The flexural modulus was 6.5 MPa, and sufficient strength was obtained.

### Example 9

A molded body was prepared and heat-treated with the same operation as in Example 1, except that the heating time during molding was set to 90° C. and the time until mold release was set to 300 seconds. For the mold release force, mold release was easily accomplished at 1.08 kN. The flexural modulus was 6.6 MPa, and sufficient strength was obtained.

### Example 10

A molded body was prepared and heat-treated with the same operation as in Example 1, except that the heating time during molding was set to 85° C. and the time until mold release was set to 350 seconds. For the mold release force, mold release was easily accomplished at 1.36 kN. The flexural modulus was 6.3 MPa, and sufficient strength was obtained.

The results of the Examples and Comparative Examples are summarized in Table 1.

### Comparative Example B

A molded body was obtained with the same operation as in Comparative Example A, except that the time until mold release was set to 500 seconds. For the force required for mold release, a very strong force of 1.85 kN was required. In addition, the protruding part was damaged during the mold release. When the flexural modulus of the obtained molded body was measured without conducting heat treatment, it was 6.4 GPa, and sufficient strength was not obtained.

### Example 11

A molded body was prepared and heat-treated with the same operation as in Example 1, except that a fibroin solution, divided into 39.0 ml portions as shown in FIG. 6, was loaded into a lyophilization block having a 5 mm diameter cylindrical through-hole as shown in FIG. 5, lyophilization of the whole block was conducted as shown in FIG. 7, silk fibroin was compressed within the block as shown in FIG. 8, to obtain base material for molding. For the mold release force, mold release was easily accomplished at 0.76 kN. The flexural modulus was 6.2 MPa, and sufficient strength was obtained.

### Example 12

A molded body was prepared and heat-treated with the same operation as in Example 1, except that as shown in FIG. 9, a fibroin solution, divided into 19.5 ml portions which amounts to ½ of 39 ml was put loaded into a lyophilization block having a 5 mm diameter cylindrical through-hole, lyophilizatoin of the whole block was conducted, silk fibroin was compressed within the block to obtain base material for molding, and as shown in FIG. 10, 2 pieces of base material for molding were loaded into a mold. For the mold release force, mold release was easily accomplished at 0.76 kN. The flexural modulus was 6.2 MPa, and sufficient strength was obtained.

### Example 13

A molded body was prepared and heat-treated with the same operation as in Example 1, except that a fibroin solution divided into 39.0 ml portions was loaded into a mold for a final molded body, as shown in FIG. 11, lyophilization was conducted of the entire mold, the state in which lyophilization was completed was changed to a state in which lyophilized silk fibroin was already loaded into a mold, as shown in FIG. 12, and a molded body was obtained by pressurizing the lyophilized silk fibroin with an upper mold and a lower mold without changing the mold as shown in FIG. 13. For the mold release force, mold release was easily accomplished at 0.76 kN. The flexural modulus was 6.2 MPa, and sufficient strength was obtained.

TABLE 1A

| | Example | Example | Example | Example | Example | Example |
|---|---|---|---|---|---|---|
| | 1 | 2 | 3 | 4 | 5 | 6 |
| Molding pressure | 500 | 20 | 10 | 500 | 500 | 500 |
| (MPa) | | | | | | |
| Molding temperature | 120 | 120 | 120 | 70 | 50 | 150 |
| (°C) | | | | | | |
| Molding time (sec) | 10 | 10 | 10 | 10 | 10 | 10 |
| Time until mold release | 30 | 30 | 30 | 30 | 30 | 30 |
| (min) | | | | | | |
| Heat treatment | 120 | 120 | 120 | 120 | 120 | 120 |
| temperature (°C) | | | | | | |
| Heat treatment time | 600 | 600 | 600 | 600 | 600 | 600 |
| (sec) | | | | | | |
| Force required for mold | 0.76 | 0.56 | 0.41 | 0.54 | 0.45 | 0.71 |
| release (kN) | | | | | | |
| Flexural modulus (GPa) | 6.2 | 4.2 | 2.8 | 4.5 | 2.3 | 5.9 |

TABLE 1B

| | | | | | Compar. | Compar. |
|---|---|---|---|---|---|---|
| | Example | Example | Example | Example | Example | Example |
| | 7 | 8 | 9 | 10 | A | B |
| Molding | 500 | 500 | 500 | 500 | 500 | 500 |
| pressure (MPa) | | | | | | |
| Molding | 180 | 120 | 90 | 85 | 120 | 120 |
| temperature (°C) | | | | | | |
| Molding time | 10 | 1 | 10 | 10 | 10 | 10 |
| (sec) | | | | | | |
| Time until mold | 30 | 30 | 300 | 350 | 30 | 500 |
| release (min) | | | | | | |
| Heat treatment | 120 | 120 | 120 | 120 | — | — |
| temperature (°C) | | | | | | |
| Heat treatment | 600 | 600 | 600 | 600 | — | — |
| time (sec) | | | | | | |
| Force required | 0.32 | 0.74 | 1.08 | 1.36 | 0.76 | 1.85 |
| for mold release | | | | | | |
| (kN) | | | | | | |
| Flexural | 3.5 | 6.5 | 6.6 | 6.3 | 1.8 | 6.4 |
| modulus (GPa) | | | | | | |

1. A method for producing a fibroin molded body, the fibroin molding body manufacturing method comprising the steps of:
loading fibroin into a mold;
heating and pressurizing the fibroin;
taking out the pressurized fibroin, wherein the pressurized fibroin forms a fibroin-molded body; and
heat-treating the fibroin molded body.

2. The fibroin molded body manufacturing method according to claim 1, wherein the heating and pressurizing is performed at 70 to 200° C. and 10 MPa or more for 1~300 seconds.

3. The fibroin molded body manufacturing method according to claim 1, wherein taking out the molded body takes place within 500 seconds after the start of heating.

4. The fibroin molded body manufacturing method according to claim 1, wherein heat-treating is performed at a temperature of 70° C. to 200° C.

5. The fibroin molded body manufacturing method according to claim 1, wherein the heating time for heat-treating is 600 seconds or longer.

6. The fibroin molded body manufacturing method according to claim 1, wherein the heating time for heat-treating is longer than the heating time for heating and pressurizing.

7. The fibroin molded body manufacturing method according to claim 1, wherein the fibroin has a bulk density of 0.7 g/cm³ to 1.2 g/cm³.

8. The fibroin molded body manufacturing method according to claim 1, additionally comprising the step of drying an aqueous solution containing fibroin inside a block for manufacturing the fibroin.

9. The fibroin molded body manufacturing method according to claim 8 further comprising the step of pressurizing the dried aqueous solution containing fibroin inside the block for manufacturing the fibroin.
